(19) United States
(12) Patent Application Publication
(10) Pub. No.: US 2004/0218817 A1
(43) Pub. Date: Nov. 4, 2004

(54) Image processing apparatus that decomposites composite images

(76) Inventors: Taku Kodama, Kanagawa (JP); Yasuyuki Nomizu, Kanagawa (JP); Junichi Hara, Kanagawa (JP); Hiroyuki Sakuyama, Tokyo (JP); Toshio Miyazawa, Kanagawa (JP); Yasuyuki Shinkai, Kanagawa (JP); Nekka Matsuura, Kanagawa (JP); Takanori Yano, Kanagawa (JP); Takayuki Nishimura, Tottori (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/753,654

(22) Filed: Jan. 7, 2004

(30) Foreign Application Priority Data
Jan. 7, 2003 (JP) 2003-001234
Jan. 5, 2004 (JP) 2004-000541

(51) Int. Cl. G06K 9/36

(52) U.S. Cl. 382/232

(57) ABSTRACT

An image processing apparatus is disclosed including: a header/code-data separating unit that separates a codestream of an image into header portions and code-data portions; a header processing unit that edits the separated header portions for generating a new codestream of a portion of the image; a code-data processing unit that selects code-data corresponding to the portion of the image from the separated code-data portions; and a codestream generation unit that generates the new codestream by combining the edited header portions and the selected code-data. The image processing apparatus can generate a new codestream and decomposite the portion of the image without decoding the codestream of the image.

The present application claims priority to the corresponding Japanese Application Nos. 2003-001234, filed on Jan. 7, 2003 and 2004-000541, filed on Jan. 5, 2004, the entire contents of which are hereby incorporated by reference.

### BACKGROUND OF THE INVENTION

1. Field of the Invention

The present invention generally relates to an image processing apparatus, and more particularly, to an image processing apparatus that can separate a part of a composite image therefrom. The present invention further relates to an image processing apparatus in which the image processing apparatus is built. The present invention yet further relates to a computer program that causes a computer to function as the image processing apparatus.

2. Description of the Related Art

Image compression/decompression technology for handling fine resolution still images is rapidly improving, but demands for even more improved image compression/decompression technology are expected to increase. JPEG is the most widely used algorithm for compressing/decompressing fine resolution still images. JPEG 2000 is an algorithm adopted as an international standard in 2001. JPEG 2000 has higher performance than JPEG, and is designed to be flexible and expandable. As a result, JPEG 2000 is expected to succeed JPEG as the algorithm for compressing/decompressing fine resolution still images in the next generation.

Since an image forming apparatus such as a printer can print a high resolution image of good quality, multiple images are often printed after being composited into a single page in order to reduce paper consumption. Likewise, multiple images are often displayed on a high resolution display unit after being composited into a single screen. The multiple images may be further reduced into thumbnails (shrunk images) and used as indexes. When multiple images are composited into a composite image (an image in which the multiple images are composited), each image (individual image) is decompressed (assuming that the image is compressed and stored in a secondary storage), and if necessary, the size of the image is adjusted.

In this case, however, the printing of a composite image requires a much longer time period than the printing of an individual image does. The printing of a composite image also requires much more memory capacity than the printing of an individual image does. The memory capacity required for the printing of a composite image may exceed the memory provided to the image forming apparatus.

Japanese Patent Laid-Open Application No. 2000-156829 discloses a technique in which a composite image is generated in small units (by the line, for example) so as to reduce memory capacity required for compositing.

Japanese Patent Laid-Open Application No. 2000-156830 discloses a technique in which the compositing of images is accelerated with extra buffers.

Japanese Patent Laid-Open Application No. 2001-148774 discloses a technique in which a designated number of images are composited.

Japanese Patent Laid-Open Application No. 10-322542 discloses a technique in which images once composited in a composite image are re-composited, the number of re-composited images being different from the number of images composited in the composite image.

It is sometimes desired that one or more individual images composited in a composite image be decomposited from the composite image. For example, one may want to duplicate with an image forming apparatus such as a copier, a part of a document in which multiple individual images are composited. One may want to print a part of a document stored in a storage unit of an image forming apparatus. He/she may want to extract only a picture composited in a composite image together with text.

In a conventional case, the document stored in the storage unit of an image forming apparatus, for example, is decompressed and loaded to memory, and then, a part of the document is decomposited.

The above conventional method, however, is complicated and requires a long time period.

### SUMMARY OF THE INVENTION

An image processing apparatus that decomposites composite images is described. In one embodiment, an image processing apparatus comprises a header/code-data separating unit that separates a codestream into header portions and code-data portions, where an image is divided into a plurality of rectangular regions, and is hierarchically encoded into code-data by transforming pixel values of each of the rectangular regions with a discrete wavelet transform. The image processing apparatus further comprises: a header processing unit that edits the separated header portions for generating a new codestream corresponding to a portion of the rectangular regions; a code-data processing unit that selects code-data corresponding to the portion of the rectangular regions from the separated code-data portions; and a codestream generation unit that generates the new codestream by combining the edited header portions and the selected code-data.

### BRIEF DESCRIPTION OF THE DRAWINGS

FIG. 1 is a block diagram for illustrating the JPEG 2000 algorithm;

FIG. 2 is a schematic diagram showing tiled components of a color image;

FIG. 3 is a schematic diagram showing sub-bands at various decomposition levels up to 3;

FIG. 4 is a data diagram showing the structure of a codestream;

FIG. 5 is a cross-sectional view of a copier according to an embodiment;

FIG. 6 is a block diagram showing a control unit of the copier according to an embodiment;

FIG. 7 is a block diagram showing an image processing apparatus of the copier according to an embodiment;

FIG. 8 is a block diagram showing a decomposite image unit of the image processing apparatus according to an embodiment;

FIGS. 9A and 9B are schematic diagrams for illustrating processing for decompositing an individual image from a composite image according to an embodiment;

FIG. 10 is a data diagram showing the structure of a codestream before being decomposited;

FIGS. 11A and 11B are data diagrams showing the structure of a codestream after being decomposited by the decomposite image unit; and

FIG. 12 is a flowchart for illustrating processing for decompositing a composite image by a copier according to an embodiment.

### DETAILED DESCRIPTION OF THE PREFERRED EMBODIMENTS

Accordingly, one or more embodiments of the present invention include a novel and useful image processing apparatus in which at least one of the above problems is eliminated.

Another and more specific embodiment of the present invention comprises an image processing apparatus that can easily decomposite one or more individual images from a composite image in a short time period.

Yet another embodiment of the present invention comprises an image forming apparatus, a method of processing an image, and a computer program that causes a computer to function as the image processing apparatus, and that can easily decomposite one or more individual images from a composite image in a short time period.

Yet another embodiment of the present invention comprises an image processing apparatus that can reduce the data amount of decomposited individual images, and as a result, reduce memory capacity required for storing the decomposited individual images.

To achieve at least one of the above embodiments, an image processing apparatus according to one embodiment of the present invention includes: a header/code-data separating unit that separates a codestream into header portions and code-data portions, wherein an image is divided into a plurality of rectangular regions, and is hierarchically encoded into code-data by transforming pixel values of each rectangular region with a discrete wavelet transform; a header processing unit that edits the separated header portions for generating a new codestream corresponding to a portion of the rectangular regions; a code-data processing unit that selects code-data corresponding to the portion of the rectangular regions from the separated code-data portions; and a codestream generation unit that generates the new codestream by combining the edited header portions and the selected code-data.

According to the above embodiments, the image processing apparatus can generate a new codestream and decomposite a portion of the image corresponding to the new codestream without decoding the code-data of the image. Since only a portion of the code-data of the rectangular region may be included in the new codestream, the data size of the new codestream can be reduced, and accordingly, memory capacity for storing the new codestream can be reduced.

The image processing apparatus may include: a receiving unit that receives image information for selecting a portion of the rectangular regions, wherein the header processing unit edits the separated header portions based on the image information; and the code-data processing unit selects code-data based on the image information.

According to the above embodiment, the image processing apparatus can generate the new codestream corresponding to a portion of the image selected by the image information.

Other embodiments, features, and advantages of the present invention will become more apparent from the following detailed description when read in conjunction with the accompanying drawings.

The preferred embodiments of the present invention are described below with reference to the drawings.

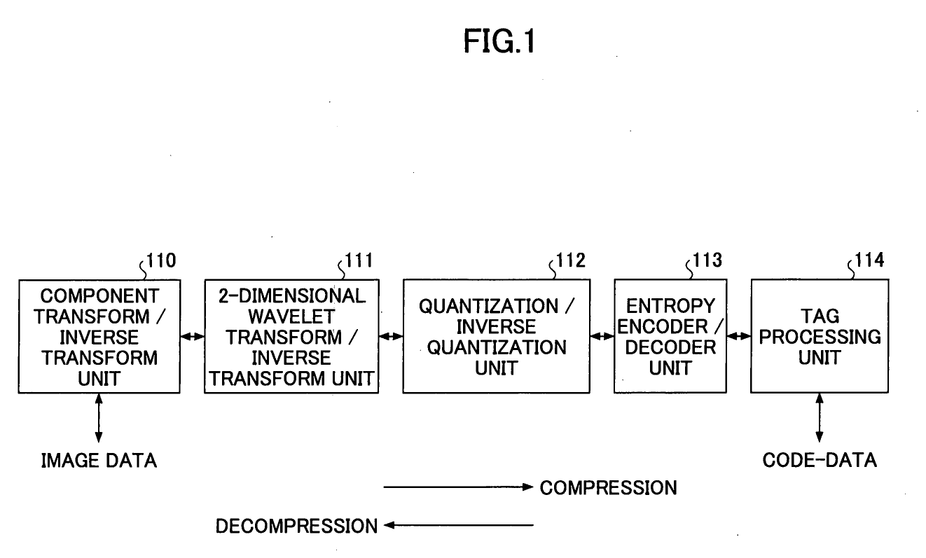

FIG. 1 is a block diagram for illustrating the algorithm of JPEG 2000. Since the algorithm of JPEG 2000 is known in the art, only a portion especially relevant to the present invention is described.

The algorithm of JPEG 2000 includes a component transform/inverse transform unit 110, a 2 dimensional wavelet transform/inverse transform unit 111, a quantization/inverse quantization unit 112, an entropy encoder/decoder unit 113, and a tag processing unit 114.

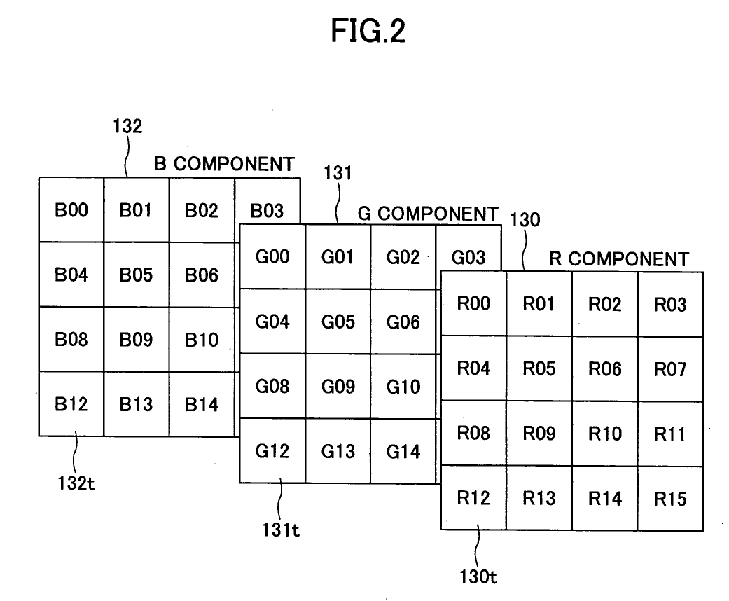

FIG. 2 is a schematic diagram showing components of a color image. In the case where the RGB color system is used, the color image is represented by 3 components 130, 131, and 132, corresponding to R-component, G-component, and B-component, respectively. The components are divided into respective multiple rectangular regions (tiles) 130t, 131t, and 132t. The color image is compressed and decompressed by tiles R00, R01, . . . , R15/G00, G01, . . . , G15/B00, B01, . . . , B15. Each tile is independently processed.

When an image is encoded, pixel values of a tile (R00 of component 130, for example) are input to the component transform unit 110 shown in FIG. 1, and are transformed into data represented in another color space. The data are transformed with 2-dimensional wavelet transform (forward transform), and are divided into multiple frequency ranges (sub-bands).

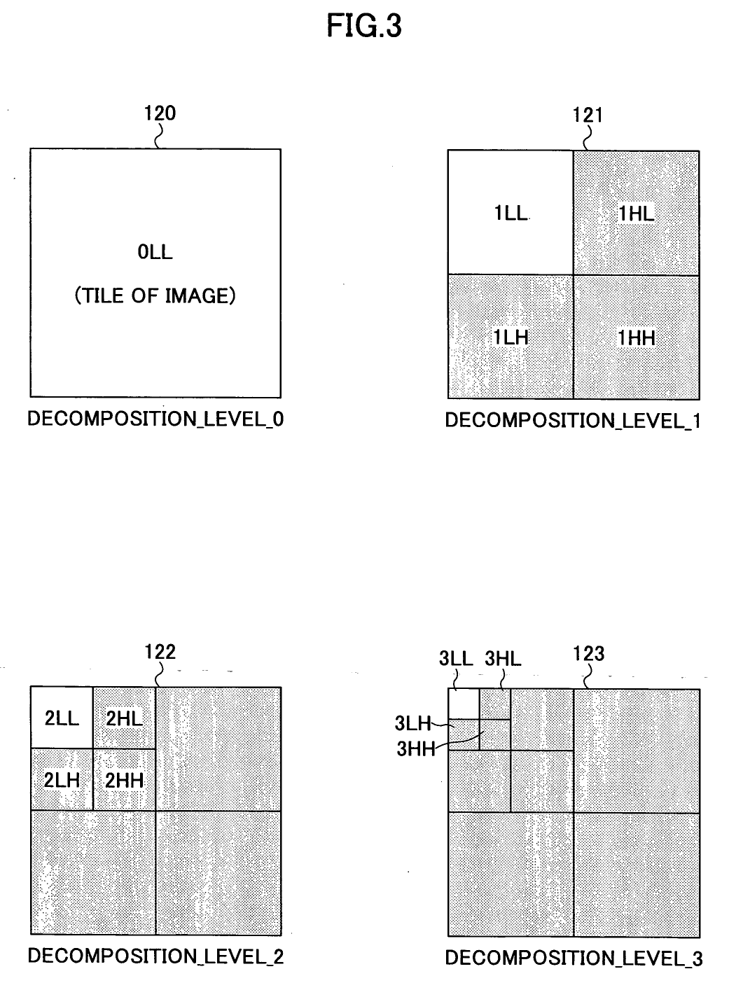

FIG. 3 shows sub-bands of a tile at decomposition levels 0, 1, 2, and 3. A sub-band 0LL of the decomposition level 0 (denoted by a reference numeral 120) is equivalent to the tile divided into the components. Sub-bands 1LL through 1HH of the decomposition level 1 (denoted by a reference numeral 121) are generated by transforming the sub-band 0LL with the 2-dimensional wavelet transform. Sub-bands 2LL through 2HH of the decomposition level 2 (denoted by a reference numeral 122) are generated by transforming the sub-band 1LL with the 2-dimensional wavelet transform. Sub-bands 3LL through 3HH of the decomposition level 3 (denoted by a reference numeral 123) are generated by transforming the sub-band 2LL with the 2-dimensional wavelet transform. The sub-bands are encoded and brought together into a codestream.

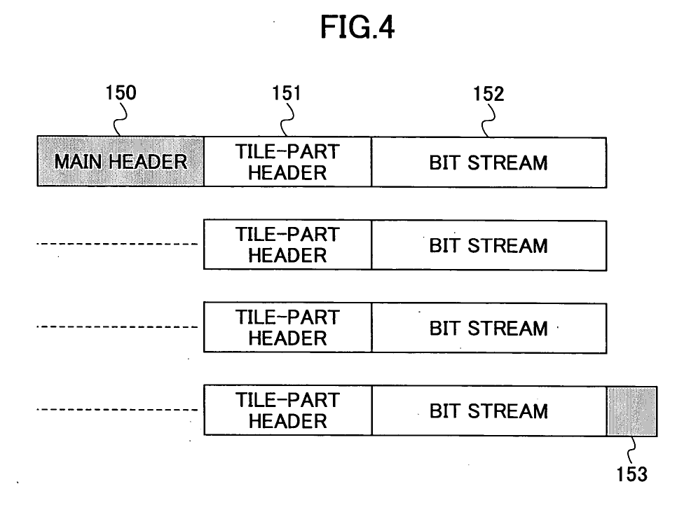

FIG. 4 is a data diagram showing the structure of the codestream. The codestream includes a main header 150, a combination of a tile-part header 151 and a bit stream 152 (if multiple tiles are included, multiple combinations are included as shown in FIG. 4), and an EOC (end of codestream) marker 153. The main header 150 includes information related to the entire codestream. The tile-part header 151 includes information related to a tile, and the bit stream 152 includes encoded data of the tile. The EOC marker indicates the end of the codestream.

When an image is decoded, the image is generated based on a codestream. The decoding of the codestream is briefly described below.

The codestream is input to the tag processing unit 114. The tag processing unit 114 interprets tags (the main header, the tile-part header, and the EOC marker) attached to the input codestream, and separates the codestream into codestreams each corresponding to a tile. The codestreams each corresponding to a tile are decoded one by one. The position of a bit to be decoded is determined based on tag information included in the codestream corresponding to a tile. The entropy decoder unit 113 decodes the coefficient values of the bit based on the codestream corresponding to a tile and a context (generated and fed back by the inverse quantization unit 112) with probabilistic estimates. The decoded coefficient values are written at the position of the bit. The inverse quantization unit 112 generates the context based on bits (already decoded) in the neighborhood of the bit to be decoded, and feeds back the context to the entropy encoder/decoder unit 113.

Data decoded in the above manner are wavelet coefficient values divided by frequency ranges. The 2-dimensional wavelet inverse transform unit 111 inverse-transforms the wavelet coefficient values with a 2-dimensional wavelet inverse transform, and generates pixel values of the tile. The component inverse transform unit 110 transforms the generated pixel values into data represented in the original color space.

The conventional JPEG algorithm encodes and decodes an image in the same manner as JPEG 2000, except that the image is divided into 8 pixels×8 pixels rectangular blocks instead of tiles, and is transformed by 2-dimensional discrete cosine transform instead of the 2-dimensional discrete wavelet transform.

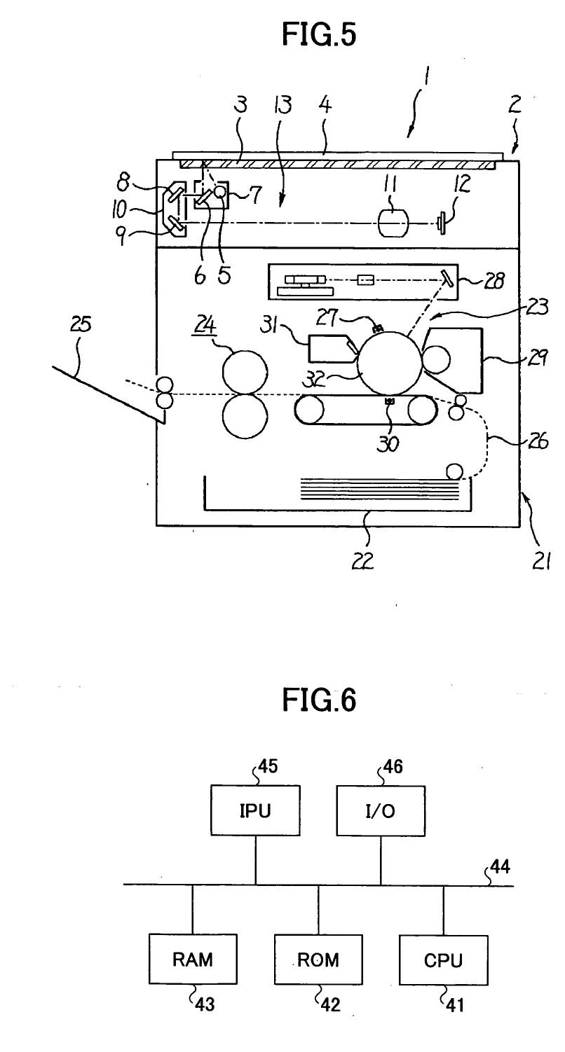

FIG. 5 is a cross-sectional view of a copier according to an embodiment. The copier 1 shown in FIG. 5 includes a scanner 2 and a printer 21 that forms (prints) an image on a recording medium such as paper based on data generated by the scanner 2 in response to the scanning of a document and output to the printer 21.

A contact glass 3 is provided on the top face of the body of the scanner 2. A document (not shown) is placed with its face down on the contact glass 3 for scanning. A platen cover 4 is provided over the contact glass 3 for holding the document.

An optical reading unit 13 is provided under the contact glass 3. The optical reading unit 13 includes a light source 5, a first movable unit 7 in which a mirror 6 is provided, a second movable unit 10 in which two mirrors 8 and 9 are provided, a focusing lens 11 that focuses light guided by the mirrors 6, 8, and 9, and a CCD (charge coupled device) image sensor 12. The CCD image sensor 12 generates photoelectric data in response to a light signal reflected by the document, the light signal being focused on the CCD image sensor 12. The photoelectric data are voltages depending on the intensity of the reflective light from the document. The first movable unit 7 and the second movable unit 10 are driven by an actuating unit such as a motor (not shown), and can freely move back and forth along the contact glass 3. When a document is being read, the first movable unit 7 moves at twice the speed at which the second movable unit 10 moves. According to the above arrangements, the optical reading unit 13 scans and reads the document.

A recording medium travels from a medium storing unit 22 in which the recording medium such as a sheet of paper is stored to a discharging unit 25 via an electrophotography type printer engine 23 and a fixing unit 24 in the printer 21.

The printer engine 23 forms with the electrophotography method a toner image on the surface of a photosensitive unit 32 using a charging unit 27, an exposure unit 28, and a development unit 29, transfers the formed toner image to the recording medium using a transfer unit 30, and cleans the surface of the photosensitive unit 32 using a cleaner 31. The printer engine 23 also fixes the transferred toner image on the recording medium by a fixing unit 24. The printer engine 23 is not limited to an electrophotography type printer. According to another embodiment, the printer engine 23 may be an ink-jet printer, a sublimation type thermal transfer type printer, and a direct thermal recording type, for example.

The copier 1 is controlled by a controller unit that may include multiple microcomputers. FIG. 6 is a block diagram showing the structure of the controller unit according to an embodiment, the controller unit related to image processing. The controller unit shown in FIG. 6 includes a CPU 41, a ROM 42, a RAM 43, an IPU 45, and an I/O 46 connected to each other via a bus 44. The CPU 41 performs various arithmetic operations and centrally controls processing. The ROM 42 stores various computer programs to be executed by the CPU 41 and also stores fixed data to be accessed by the CPU 41. The RAM 43 provides the CPU 41 with a working memory region. The IPU (Image Processing Unit) 45 includes hardware resources relevant to various image processing tasks. The ROM 42 is, for example, a nonvolatile memory such as a flash memory. The computer programs stored in the ROM 42 may be replaced with other computer programs downloaded from an external resource via the I/O port 46 under the control by the CPU 41.

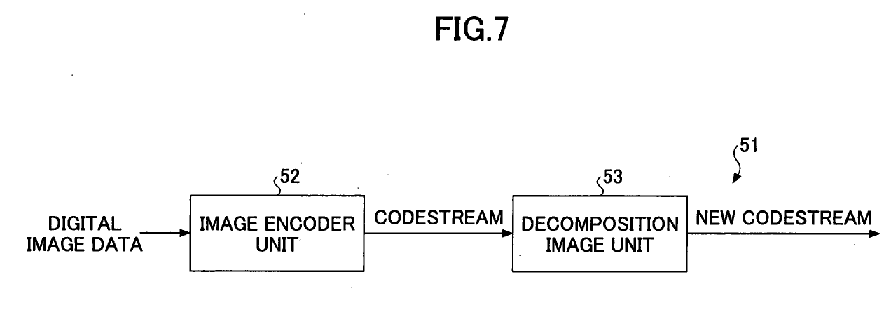

FIG. 7 is a block diagram showing the structure of an image processing apparatus 51 according to an embodiment. The image processing apparatus 51 includes an image encoder unit 52 and a decomposite image unit 53. The image encoder unit 52 encodes and compresses images. That is, the image encoder unit 52 encodes the digital image data of multiple images into code data with the JPEG 2000 algorithm, the digital image data being generated by the scanner 2 and processed by the IPU 45 for adjusting white shading, for example. The image encoder unit 52 generates codestreams based on the code data. That is, the pixel values of the entire image or the pixel values of each rectangular regions (tiles) with which the image is divided are transformed with the discrete wavelet transform, and the wavelet coefficient values are hierarchically encoded for compression. The decomposite image unit 53 decomposites a portion of an image that has one or more tiles.

The image encoder unit 52 includes the functional blocks shown in FIG. 1, and encodes the digital image data with the JPEG 2000 algorithm. According to an embodiment, the function of the image encoder unit 52 may be embodied by a hardware resource of the IPU 45. According to another embodiment, the function of the image encoder unit 52 may be embodied by the CPU 41 on which a computer program stored in the ROM 42 is executed. According to an embodiment, the function of the decomposite image unit 53 may be embodied by a hardware resource of the IPU 45. According to another embodiment, the function of the decomposite image unit 53 may be embodied by the CPU 41 on which a computer program stored in the ROM 42 is executed.

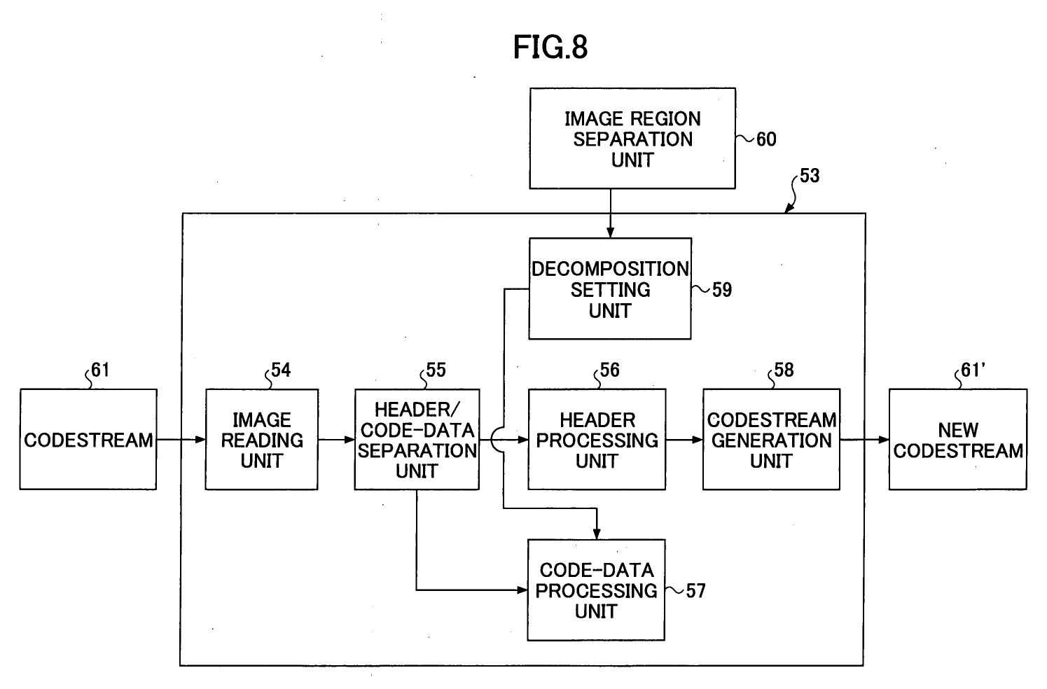

FIG. 8 is a block diagram showing the structure of the decomposite image unit 53. The decomposite image unit 53 includes image reading unit 54, a header/code-data separation unit 55, a header processing unit 56, a code-data processing unit 57, a codestream generation unit 58, and a decomposite setting unit 59.

A description is given of the case in which a composite image is decomposited by the decomposition image unit 53. When a user operates an operations panel (not shown) of the copier 1, and gives an instruction for decompositing and duplicating a portion of a document, the scanner 2 scans and reads the document and generates digital image data. The digital image data are processed by the IPU 45 for adjusting the white shading, for example, and are encoded into a codestream by the image encoding unit 52. The encoded digital image data are output as a codestream to the decomposition image unit 53.

The user can designate which tiles are to be decomposited by specifying a portion of the image with the operations panel (not shown). An image region separation unit 60 determines which tiles of the composite image (with which the image is divided at least in the vertical or horizontal direction) are to be decomposited based on the user's instruction. The image region separation unit transmits a signal indicating the tiles to be decomposited to the decomposition setting unit 59. The decomposition setting unit 59 sets the tiles to be decomposited from the composite image based on the image information. According to another embodiment, the image region separation unit 60 may automatically separate image regions using a technique know to the art based on the digital image data by identifying text and photographs, for example, and transmit the image information to the decomposition setting unit 59.

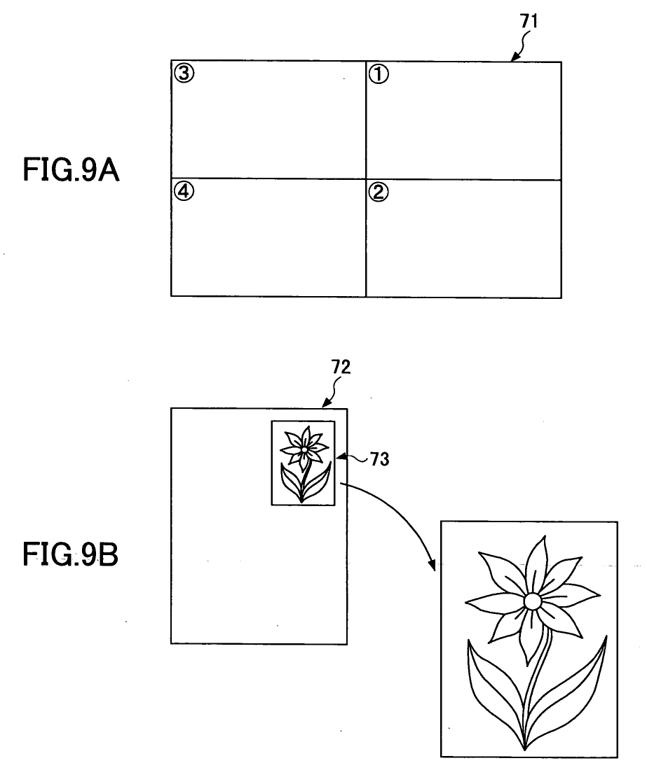

In the case of an image 71 in which 4 tiles 1 through 4 are composited in the rows and columns as shown in FIG. 9A, the decomposition setting unit 59 selects one of the 4 tiles. The image reading unit 54 acquires the codestream 61 of the image. The codestream 61 is separated into header portions and code-data portions by the header/code-data separation unit 55. Subsequently, the header processing unit 56 changes an image size contained in the separated main header to the image size of a decomposited image. New tile-part headers are generated, and tile indexes are attached to the generated tile-part headers.

The code-data processing unit 57 extracts code-data portions designated by the image region separation unit 60 from the code-data portions separated by the header/code-data separation processing unit 55. The code-data processing unit 57 extracts specific code-data from the separated code-data portions, specifically, wavelet coefficients of specific decomposition levels, and outputs the extracted code-data to the codestream generation unit 58.

The codestream generation unit 58 combines the headers generated by the header processing unit 56 and the code-data extracted by the code-data processing unit 57 into a codestream defined by JPEG 2000. As a result, a codestream 61′ of the decomposited image is generated. The codestream 61′ includes only tiles of the original image designated by the image region separation unit 60.

It is noted that, in the above description, each individual image includes only one tile in order to make the description easy to understand. According to another embodiment, however, the individual image may include multiple tiles. If an individual image including multiple tiles is to be decomposited, the codestream 61′ is generated so as to include the code-data of the multiple tiles. The codestream 61′ is transmitted to the printer engine 23, and stored in image memory (not shown). The codestream 61′ is decoded by a decoder unit and printed by the printer engine 23.

Additionally, as described above, if the image region separation unit 60 automatically identifies image regions such as photographs from image regions such as text using a technique known to the art, and transmits image information indicating the image regions corresponding to the photographs, for example, the copier 1 can decomposites only the photographic region 73 from the composite image 72 as shown in FIG. 9B.

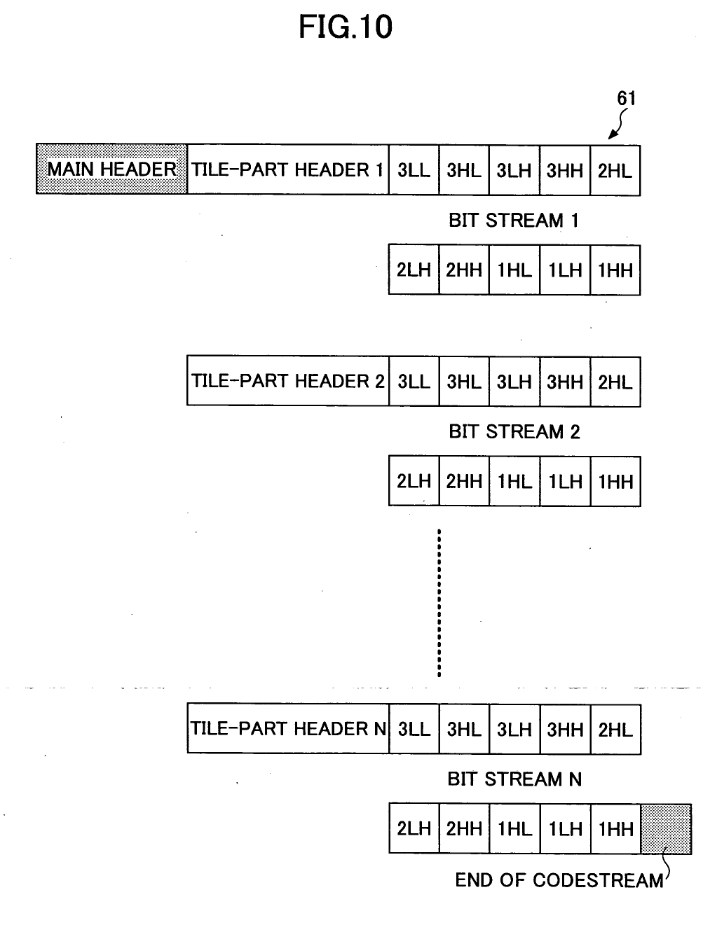

FIG. 10 is a data diagram showing the structure of a codestream 61 of a composite image according to an embodiment. The codestream 61 includes a main header, tile-part headers 1 through N, bit streams 1 through N, and an EOC marker. The codestream 61 includes “N” tiles.

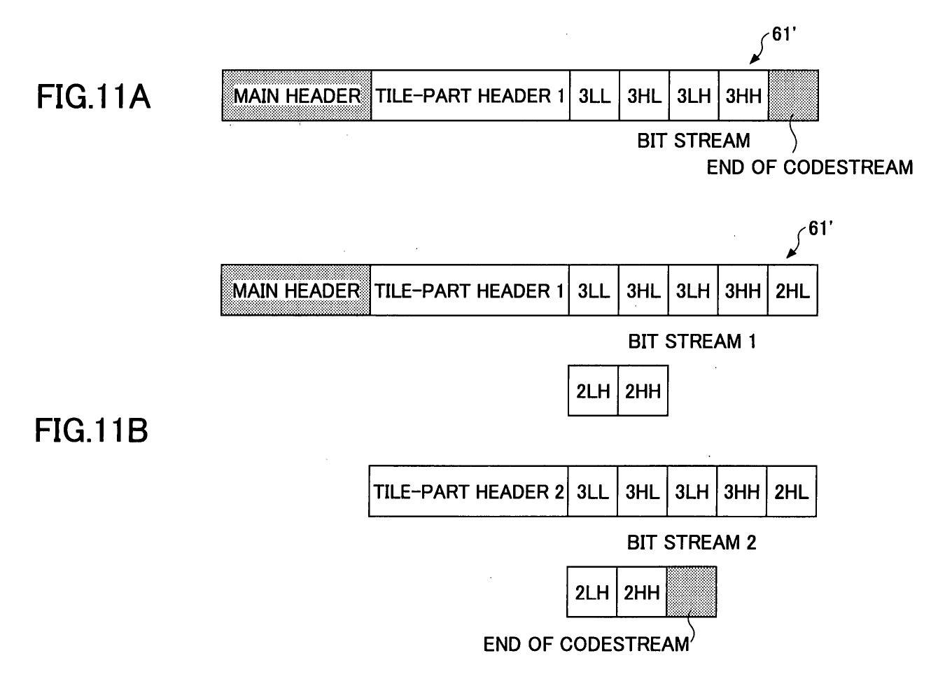

FIG. 11A is a data diagram showing the codestream 61′ of a decomposited image. As shown in FIG. 11A, the codestream 61′ includes a main header, a tile-part header, a bit stream, and an EOC marker. The codestream 61′ corresponds to only a tile designated by the image region separation unit 60. The bit stream of the codestream 61′ includes only low frequency component sub-bands 3LL through 3HH (decomposition level 3). If necessary, it is possible to include in the bit stream all sub-bands 3LL through 1HH (decomposition levels 3 through 1), and sub-bands 3LL through 2HH (decomposition levels 3 and 2). Additionally, it is possible to include in the codestream 61′ multiple files designated by the image region separation unit 60. FIG. 11B shows the case in which the sub-bands 3LL through 2HH (decomposition levels 3 and 2) are included in the codestream 61′.

As is apparent from FIGS. 10 and 11, the codestream 61 input to the image reading unit 54 is separated into header portions and code-data portions. The main header of the codestream 61 and the tile-part headers of the tiles designated by the image region separation unit 60 are edited and used as the main header and the tile-part headers, respectively, of the codestream 61′.

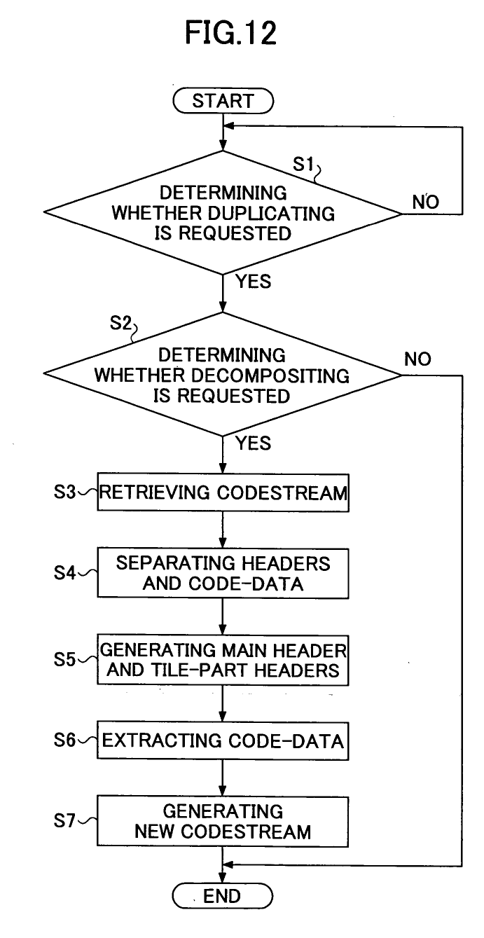

FIG. 12 is a flowchart for illustrating the decompositing of a composite image by the copier 1 according to an embodiment. When the copier 1 receives a request from a user to duplicate a composite image of which a codestream is stored in a storage unit (not shown) provided in the copier 1 (yes in step S1), the copier 1 makes a determination whether the copier 1 is requested to decomposite the image of the document (step S2). If the copier 1 determines that it is not requested to decomposite the image of the document (no in step S2), the process is terminated.

If the copier 1 determines that it is requested to decomposite the image of the document (yes in step S2), the image reading unit 54 retrieves the codestream from the storage unit (step S3), and the header/code-data separation unit 55 separates header portions and code-data portions (step S4).

Subsequently, the header processing unit 56 edits the main header and the tile-part headers of the retrieved codestream thereby to form the main header and the tile-part headers of the codestream of a decomposited image (step S5). Only the code-data portions of the tiles selected by the user are separated, and wavelet coefficients of a decomposition level are extracted (step S6). The main header and the tile-part headers generated in step S5, and the wavelet coefficients extracted in step S6 are combined thereby to form a new codestream (step S7). The process is then terminated.

As described above, the image processing apparatus 51 is built in the copier 1 according to an embodiment of the present invention. The image processing apparatus 51, however, is applicable to various electronic devices for handling images. According to another embodiment, the image processing apparatus 51 may be applicable to a multifunctional peripheral (MFP) that alone functions as a copier, a printer, a facsimile machine, and a scanner. The MFP is often equipped with a storage unit such as an HDD. The MFP in which the image processing apparatus 51 is built can decomposite a composite image stored in the storage unit into multiple individual images, and print any of the decomposited individual images. The MFP can transmit the decomposited individual images as a facsimile machine to another MFP or a facsimile machine connected to the MFP.

According to yet another embodiment, the present invention can be applied to an information processing apparatus such as a personal computer by providing a computer program that causes the information processing apparatus to function as the image processing apparatus 51. It is also possible to provide a computer readable recording medium such as an optical disk, a magneto-optical disk, and a flexible disk storing the computer program therein.

The present invention is not limited to these embodiments, but variations may be made without departing from the scope of the present invention.

This patent application is based on Japanese Priority Patent Applications No. 2003-001234 filed on Jan. 7, 2003, and No. 2004-000541 filed on Jan. 5, 2004, the entire contents of which are hereby incorporated by reference.

What is claimed is:

1. An image processing apparatus, comprising:
a header/code-data separating unit to separate a codestream into header portions and code-data portions, wherein an image is divided into a plurality of rectangular regions, and is hierarchically encoded into code-data by transforming pixel values of each of the rectangular regions with a discrete wavelet transform;
a header processing unit to edit the separated header portions for generating a new codestream corresponding to a portion of the rectangular regions;
a code-data processing unit to select code-data corresponding to the portion of the rectangular regions from the separated code-data portions; and
a codestream generation unit to generate the new codestream by combining the edited header portions and the selected code-data.

2. The image processing apparatus as claimed in claim 1, further comprising:
a receiving unit to receive image information for selecting the portion of the rectangular regions;
wherein
the header processing unit edits the separated header portions based on the image information; and
the code-data processing unit selects the code-data based on the image information.

3. The image processing apparatus as claimed in claim 2, wherein
the receiving unit receives the image information for selecting the portion of the rectangular regions into which the image is divided in one of horizontal directions, vertical directions, and both.

4. The image processing apparatus as claimed in claim 2, wherein when image information designating the portion of the rectangular regions, the portion corresponding to a photograph, is received, a new codestream corresponding to the photograph is generated.

5. An image forming apparatus, comprising:
a scanner to read a document;
an image encoder unit to transform with a discrete wavelet transform, pixel values of the read document as a whole or, when the read document is divided into a plurality of rectangular regions, by the rectangular region into wavelet coefficients, encodes the wavelet coefficients hierarchically into code-data, and combines the code-data into a codestream;
the image processing apparatus as claimed in claim 1 to process the codestream into a new codestream; and
a printer engine to form an image based on the new codestream on a recording medium.

6. A method of processing an image, comprising:
separating a codestream into header portions and code-data portions, wherein the image is divided into a plurality of rectangular regions, and is hierarchically encoded into code-data by transforming pixel values of each rectangular region with a discrete wavelet transform;
editing the separated header portions for generating a new codestream corresponding to a portion of the rectangular regions;
selecting code-data corresponding to the portion of the rectangular regions from the separated code-data portions; and
generating the new codestream by combining the edited header portions and the selected code-data.

7. An article of manufacture having one or more recordable medium storing instructions which, when executed by a computer, cause the computer to function as:
a header/code-data separating unit that separates a codestream into header portions and code-data portions, wherein an image is divided into a plurality of rectangular regions, and is hierarchically encoded into code-data by transforming pixel values of each of the rectangular regions with a discrete wavelet transform;
a header processing unit that edits the separated header portions for generating a new codestream corresponding to a portion of the rectangular regions;
a code-data processing unit that selects code-data corresponding to the portion of the rectangular regions from the separated code-data portions; and
a codestream generation unit that generates the new codestream by combining the edited header portions and the selected code-data.

8. The article of manufacture as claimed in claim 7, further comprising instructions which, when executed by the computer, cause the computer to function as:
a receiving unit that receives image information for selecting the portion of the rectangular regions;
wherein
the header processing unit edits the separated header portions based on the image information; and
the code-data processing unit selects the code-data based on the image information.

9. The article of manufacture as claimed in claim 8, wherein
the computer functioning as the receiving unit receives the image information for selecting the portion of the rectangular regions into which the image is divided in one of horizontal directions, vertical directions, and both.

10. The article of manufacture as claimed in claim 8, wherein when image information designating a portion of the rectangular regions, the portion corresponding to a photograph, is received, a new codestream corresponding to the photograph is generated.
